(19) United States
(12) Patent Application Publication
(10) Pub. No.: US 2023/0240283 A1
(43) Pub. Date: Aug. 3, 2023

(54) Automatic Freezing Treatment Apparatus, Automatic Freezing Treatment Method, and Freezing Vessel

(71) Applicants: Shimadzu Corporation, Kyoto-shi (JP); KOGA FUMITOSHI WOMEN'S CLINIC, Fukuoka-shi (JP)

(72) Inventors: Tomohiro TANAKA, Kyoto-shi (JP); Fumitoshi KOGA, Fukuoka-shi (JP)

(21) Appl. No.: 18/086,335

(22) Filed: Dec. 21, 2022

(30) Foreign Application Priority Data
Jan. 31, 2022 (JP) 2022-013066

(51) Int. Cl. A01N 1/02; G05B 15/02; G05D 7/06

(52) U.S. Cl. CPC A01N 1/0257; A01N 1/0268; G05B 15/02; G05D 7/0617

(57) ABSTRACT

A freezing apparatus includes a tube that stores a freezing target, an electric pipetter that is actuated for injection and discharge of a liquid into and from a tube and for movement of the tube, and a liquid nitrogen tank that stores refrigerant for freezing the freezing target. The tube has, at a bottom thereof, an opening smaller in size than the freezing target. The electric pipetter discharges the liquid from the tube through the opening after the injection of the liquid into the tube, and moves the tube to the liquid nitrogen tank.

### BACKGROUND OF THE INVENTION

### Field of the Invention

The present invention relates to an automatic freezing processing apparatus, an automatic freezing processing method, and a freezing vessel.

### Description of the Background Art

Technology for freeze-preservation of a cell (freezing target), such as a fertilized embryo or an egg, has been developed as technology useful in an infertility treatment. In freeze-preservation of cells, a target cell such as an embryo or an egg is placed in a freezing vessel, and the cell is subjected to a freezing pretreatment. The cell placed in the freezing vessel is then quickly frozen by liquid nitrogen. In the freezing pretreatment, the cell is immersed in an equilibration solution (ES) and a vitrification solution (VS). This achieves substitution and vitrification of a cell sap inside the cell.

When manually performing the freezing pretreatment, an embryologist traps a target at a tip by drawing in and out with the mouth using a glass Pasteur pipette connected to a mouthpiece by a tube, thus transporting the target to the equilibration solution and to the vitrification solution and washing the target. For the freezing pretreatment, for example, U.S. Pat. No. 9,826,733 discloses technology of injecting an equilibration solution into a hollow in which an embryo is placed, collecting the equilibration solution, injecting the vitrification solution, and collecting the vitrification solution.

### SUMMARY OF THE INVENTION

In the technology as disclosed in U.S. Pat. No. 9,826,733, a freezing target (such as an embryo) may be collected together in collection of the equilibration solution or the vitrification solution. In contrast, if the operator such as an embryologist fears the collection of the freezing target and a solution to be collected in the colleting operation is collected insufficiently, the solution to be collected may remain in the freezing target as a foreign matter. This requires the operator to operate carefully, leading to a heavy burden on the operator.

The present invention has been made in view of the above circumstances. An object of the present invention is, in freeze-preservation, to provide technology of reducing a burden on an operator in a pretreatment of a freezing target while avoiding a situation where the freezing target is accidentally collected and a situation where a solution to be collected remains in the freezing target.

An automatic freezing processing apparatus according to an aspect of the present disclosure includes a vessel that stores a freezing target, a working unit configured for injection and discharge of a liquid into and from the vessel and for movement of the vessel, and a refrigerant container that stores refrigerant for freezing the freezing target. The vessel has, at a bottom thereof, an opening smaller in size than the freezing target. The working unit discharges the liquid from the vessel through the opening after the injection of the liquid into the vessel, and moves the vessel to the refrigerant container.

An automatic freezing processing method according to an aspect of the present disclosure includes: injecting a liquid into a vessel having, at a bottom thereof, an opening smaller in size than a freezing target; discharging the liquid from the vessel through the opening after injecting the liquid; and moving the vessel to a refrigerant container after discharging the liquid.

A freezing vessel according to an aspect of the present disclosure is a freezing vessel for immersing a freezing target into a liquid for a freezing pretreatment. The freezing vessel includes a placement portion that allows the liquid to pass therethrough and the freezing target to be placed therein.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows an overall configuration of a freezing apparatus 100.

FIG. 2 shows a configuration of a tube 200.

FIG. 3 shows a structure of a cap 300.

FIG. 4 shows an example block diagram of freezing apparatus 100.

FIG. 5 is a flowchart of a process performed in freezing apparatus 100.

FIG. 6 is a flowchart of a subroutine of an equilibration process shown in FIG. 5.

FIG. 7 is a flowchart of a subroutine of a vitrification process shown in FIG. 5.

FIGS. 8 to 27 each show states of freezing apparatus 100.

FIG. 28 schematically shows an overall configuration of a freezing apparatus 100A.

FIG. 29 is a flowchart of a process performed in freezing apparatus 100A.

FIG. 30 is a flowchart of a subroutine of an equilibration process of FIG. 29.

FIG. 31 is a flowchart of a subroutine of a vitrification process of FIG. 29.

FIGS. 32 to 34 are each diagrams for illustrating states of freezing apparatus 100A.

FIG. 35 shows a configuration of a variation of tube 200.

### DESCRIPTION OF THE PREFERRED EMBODIMENTS

Embodiments of the present disclosure will now be described in detail with reference to the drawings. The same or corresponding parts have the same reference characters allotted, and description thereof will not be repeated.

### Embodiment 1

<Automatic Freezing Treatment Apparatus>

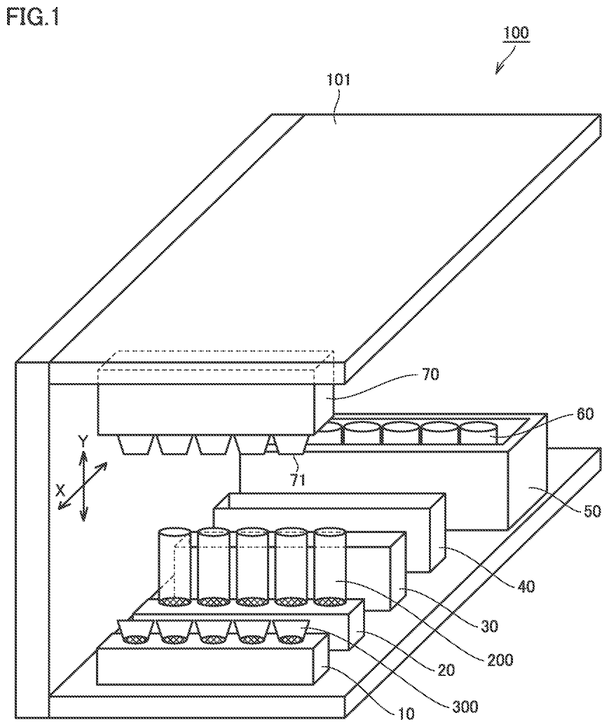

FIG. 1 schematically shows an overall configuration of a freezing apparatus 100. Freezing apparatus 100 is an example of the automatic freezing processing apparatus. Freezing apparatus 100 freezes a freezing target, such as a fertilized embryo or an egg, after a pretreatment.

As shown in FIG. 1, freezing apparatus 100 includes a cap holder 10, a tube holder 20, an ES reservoir 30, a VS reservoir 40, a liquid nitrogen tank 50, an electric pipetter 70, and a case 101. Case 101 covers the exterior of freezing apparatus 100.

One or more caps 300 are placed in cap holder 10. One or more tubes 200 are placed in tube holder 20. Tube 200 is an example of the freezing vessel.

ES reservoir 30 stores an ES. VS reservoir 40 stores a VS. Each of the ES and the VS is an example of the liquid used in the pretreatment of the freezing target. Liquid nitrogen tank 50 stores liquid nitrogen. The liquid nitrogen is an example of the freezing refrigerant. In liquid nitrogen tank 50, one or more freezing canes 60 are immersed in the refrigerant. Each freezing cane 60 houses one tube 200.

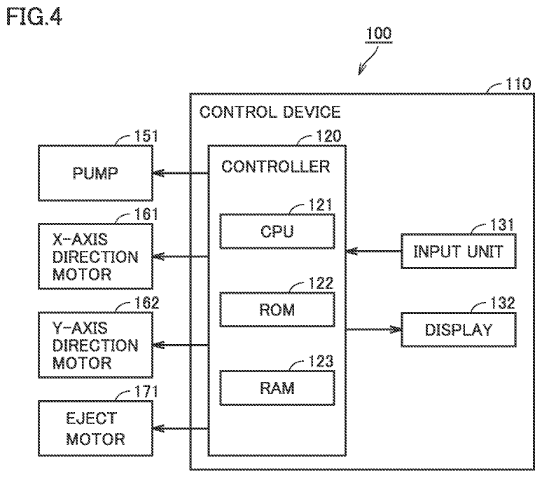

Electric pipetter 70 includes one or more nozzles 71 and sends air to each of one or more tubes 200 through a corresponding one of one or more nozzles 71. Air is sent with a pump 151, which will be described below with reference to FIG. 4, for example. FIG. 1 shows the X-axis and the Y-axis. The X-axis indicates a direction in which cap holder 10, tube holder 20, ES reservoir 30, VS reservoir 40, and liquid nitrogen tank 50 are arranged. The Y-axis indicates the vertical direction. The position of electric pipetter 70 can be controlled such that the position of each of one or more nozzles 71 moves in the X-axis direction and the Y-axis direction, as will be described below with reference to FIG. 4 or the like.

<Tube>

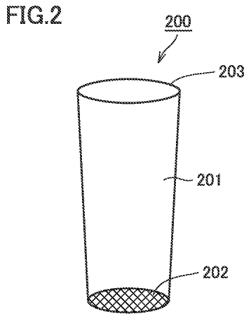

FIG. 2 shows a configuration of tube 200. Tube 200 includes a base 201 and a bottom 202. Base 201 has a columnar shape. More specifically, base 201 is tapered to have a diameter decreasing from an upper end 203 toward bottom 202. This improves mold releasability in manufacture of tube 200 by mold injection and also improves a degree of adhesion between cap 300 or chips 401, 402 and tube 200. Bottom 202 has a net structure. Base 201 and bottom 202 are made of, for example, a synthetic resin such as polyprophlene. For the sake of convenience, FIG. 1 shows tube 200 having base 201 that is not tapered. Base 201 of tube 200 may be tapered as shown in FIG. 2 or may not be tapered as shown in FIG. 1.

The size of the gap between the meshes of bottom 202 is smaller than the size of the freezing target. In one implementation, the freezing target is a fertilized egg. The fertilized egg has a size of approximately 140 μm, and each of the vertical length and the horizontal length of the gap is smaller than 140 μm (e.g., several tens of micrometers). Each of the vertical length and the horizontal length of the gap may be not greater than half the size of the fertilized egg (e.g., approximately 50 to 70 μm).

The gap between the meshes of bottom 202 is an example of the opening of tube 200. As long as bottom 202 of tube 200 has an opening, bottom 202 is not required to have a net structure.

Bottom 202 of tube 200 causes a liquid such as ES and VS to pass therethrough while holding freezing target 900. This eliminates the need for the operator to manually remove the liquid from tube 200 with freezing target 900 immersed in tube 200. Thus, such a situation can be avoided in which the liquid is removed insufficiently from tube 200 as the operator fears removal of freezing target 900.

<Cap>

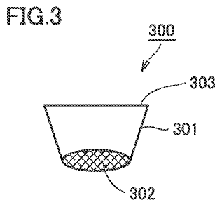

FIG. 3 shows a structure of cap 300. Cap 300 includes a base 301 and a bottom 302. Base 301 is tapered to have a diameter decreasing from upper end 303 toward bottom 302. This improves mold releasability in manufacture of cap 300 by mold injection and also improves a degree of adhesion between tube 200 and cap 300. Base 301 and bottom 302 are made of, for example, a synthetic resin such as polyprophlene. Base 301 may have a recess formed in its external side surface, and tube 200 may have a protrusion formed in its internal side surface near upper end 203. This reliably avoids a situation where cap 300 fixed to tube 200 becomes separated from tube 200.

Bottom 302 has a net structure. The mesh of bottom 302 may have a structure similar to the mesh of bottom 202 of tube 200. The gap between the meshes of bottom 302 is an example of the opening of cap 300. As long as cap 300 has an opening, cap 300 is not required to have a net structure at bottom 302.

The outside diameter of base 301 near bottom 302 is nearly the same as the inside diameter of base 201 of tube 200 near upper end 203. In other words, cap 300 covers tube 200 as its portion near bottom 302 is fitted into upper end 203 of tube 200.

A thread groove may be formed in the outer surface of base 301 near bottom 302 and in the inner surface of base 201 of tube 200 near upper end 203. Cap 300 may be screwed into tube 200 according to the threaded structure, thereby being fixed to tube 200.

<Control Block>

FIG. 4 shows an example block diagram of freezing apparatus 100. Freezing apparatus 100 includes a control device 110. Control device 110 includes a controller 120, an input unit 131, and a display 132. Controller 120 includes a central processing unit (CPU) 121, a read only memory (ROM) 122, and a random access memory (RAM) 123.

CPU 121 comprehensively controls freezing apparatus 100. CPU 121 deploys a program stored in ROM 122 to RAM 123 and executes the program. ROM 122 stores a program in which the procedure of freezing apparatus 100 is described. RAM 123 serves as a work area when CPU 121 executes the program, and temporarily stores the program or data in execution of the program, or the like.

Input unit 131 accepts an input including an instruction to freezing apparatus 100 from the user. Input unit 131 is, for example, a keyboard, a mouth, or a touch panel. Display 132, which is a display device that displays various screens, displays a state of process in freezing apparatus 100. Display 132 includes, for example, a display such as a liquid crystal display or an organic electro luminescence (EL) display.

Freezing apparatus 100 further includes a pump 151, an X-axis direction motor 161, a Y-axis direction motor 162, and an eject motor 171.

Pump 151 is driven for discharging and sucking air through a nozzle 71. X-axis direction motor 161 is driven for moving electric pipetter 70 in the X-axis direction. Y-axis direction motor 162 is driven for moving nozzle 71 of electric pipetter 70 in the Y-axis direction. Freezing apparatus 100 is equipped with a member that forms a mechanism for coupling electric pipetter 70 to X-axis direction motor 161 and Y-axis direction motor 162.

Eject motor 171 is driven for detaching, from nozzle 71, cap 300 attached to the tip of each of one or more nozzles 71. Electric pipetter 70 is equipped with a member that forms a mechanism for detaching cap 300 from nozzle 71.

In freezing apparatus 100, control device 110, pump 151, X-axis direction motor 161, Y-axis direction motor 162, and eject motor 171 are housed in, for example, case 101.

<Flow of Treatment>

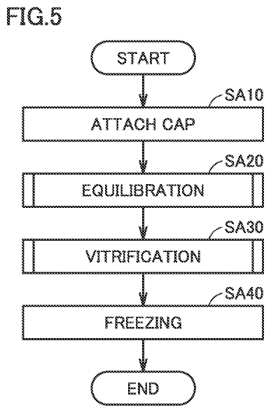

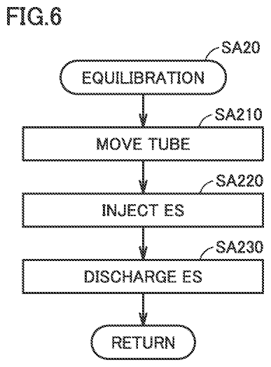

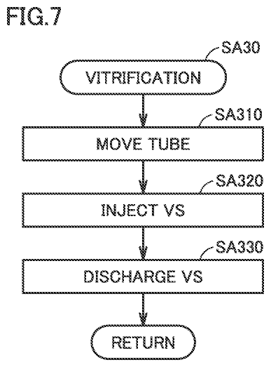

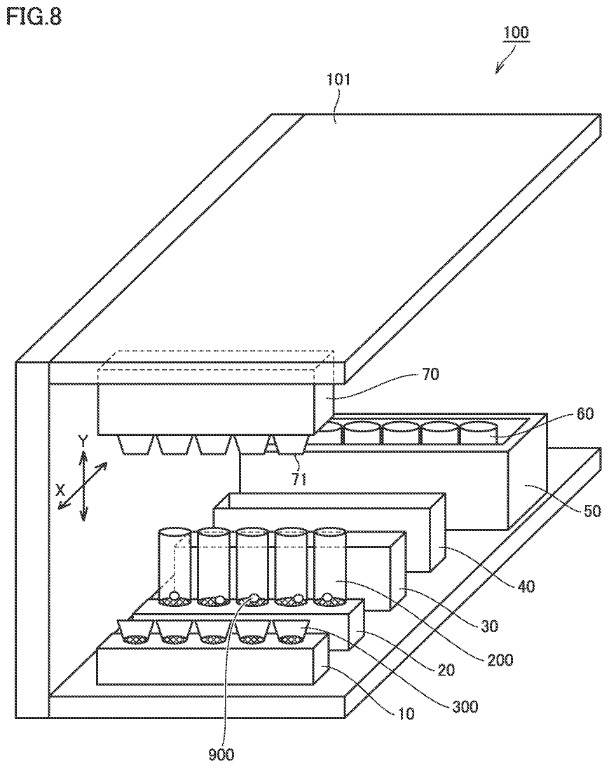

FIG. 5 is a flowchart of a process performed in freezing apparatus 100. In one implementation, freezing apparatus 100 performs the process of FIG. 5 as CPU 121 executes a given program. FIGS. 6 and 7 are each flowcharts of subroutines of the process shown in FIG. 5. FIGS. 8 to 28 each show states of freezing apparatus 100. The process of FIG. 5 starts with freezing target 900 stored in tube 200, as show in FIG. 8. Freezing target 900 is arranged in tube 200 manually or by freezing apparatus 100.

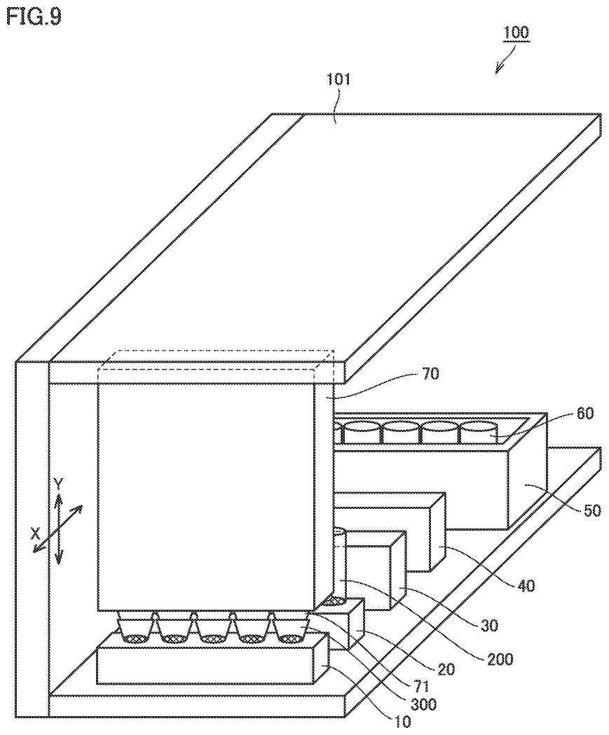

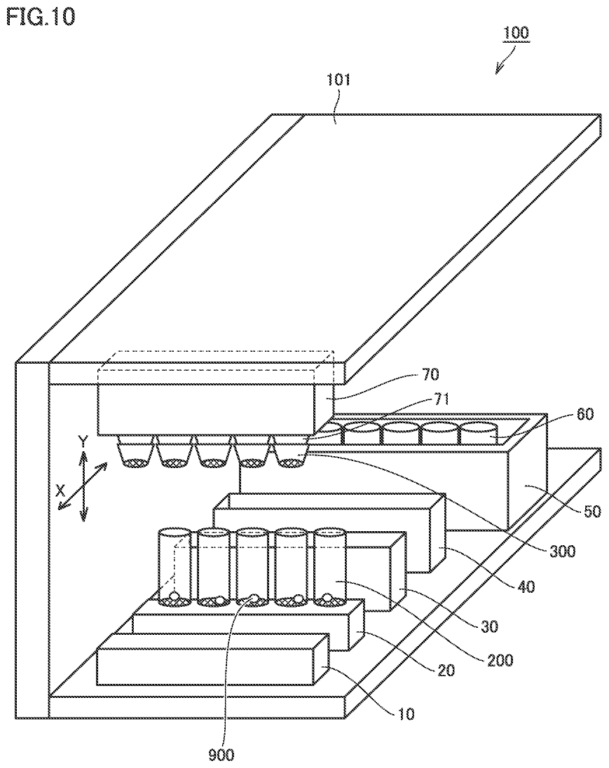

Referring to FIG. 5, in step SA10, freezing apparatus 100 attaches cap 300 to nozzle 71. In one implementation, freezing apparatus 100 drives Y-axis direction motor 162, thereby changing the position of nozzle 71 from the position shown in FIG. 8 to the position shown in FIG. 9. Thus, each of one or more nozzles 71 is inserted into a corresponding one of one or more caps 300 placed in cap holder 10. Subsequently, freezing apparatus 100 drives Y-axis direction motor 162, thereby changing the position of nozzle 71 from the position shown in FIG. 9 to the position shown in FIG. 10. Thus, each of one or more nozzles 71 is raised with cap 300 attached thereto.

In step SA20, freezing apparatus 100 performs equilibration of freezing target 900. FIG. 6 shows a subroutine of step SA20.

Referring to FIG. 6, in step SA210, freezing apparatus 100 moves tube 200 to ES reservoir 30. An example of the movement of tube 200 to ES reservoir 30 will be described with reference to FIGS. 10 to 15.

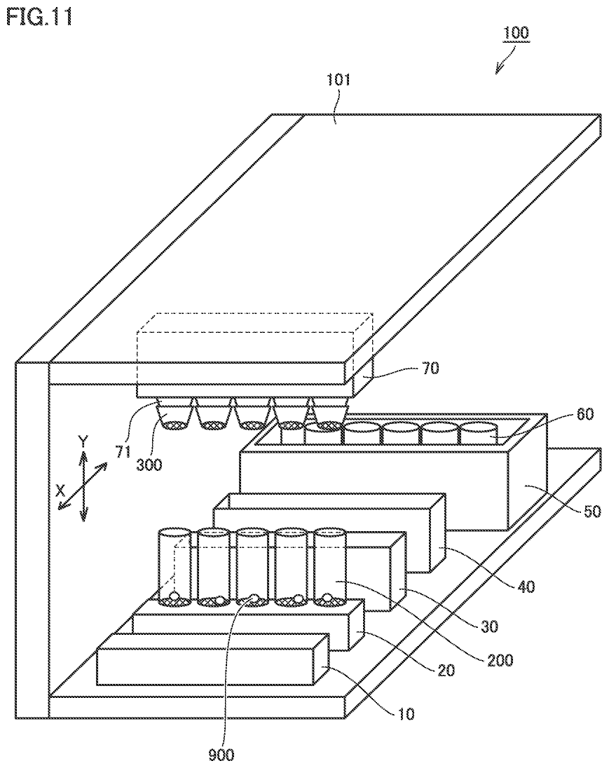

Freezing apparatus 100 moves electric pipetter 70 with cap 300 attached to nozzle 71, as shown in FIG. 10, to above tube holder 20 (FIG. 11).

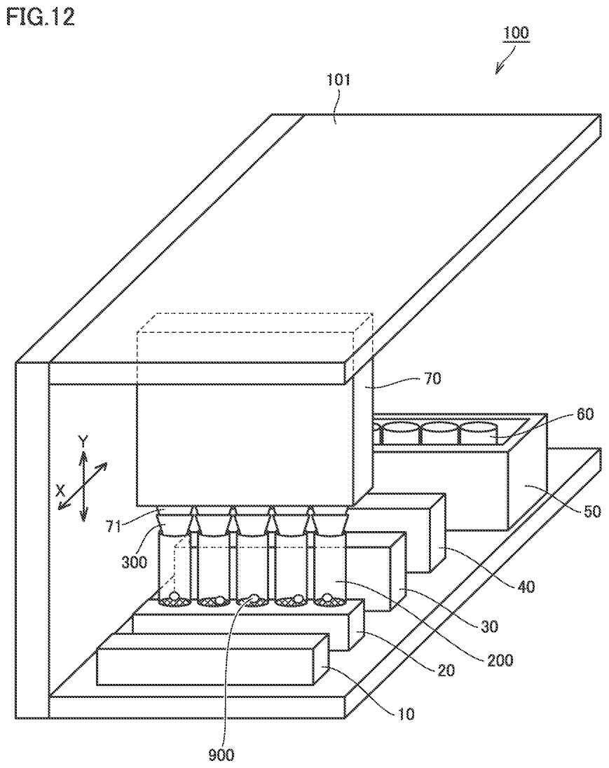

Freezing apparatus 100 then moves nozzle 71 downward (FIG. 12). Thus, cap 300 is fixed to tube 200 with cap 300 inserted into upper end 203 of tube 200. In other words, cap 300 and tube 200 are attached to nozzle 71.

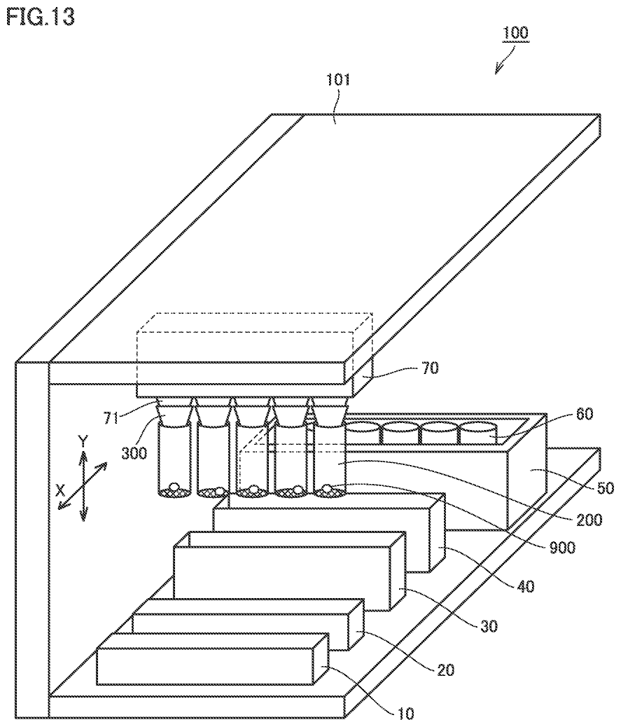

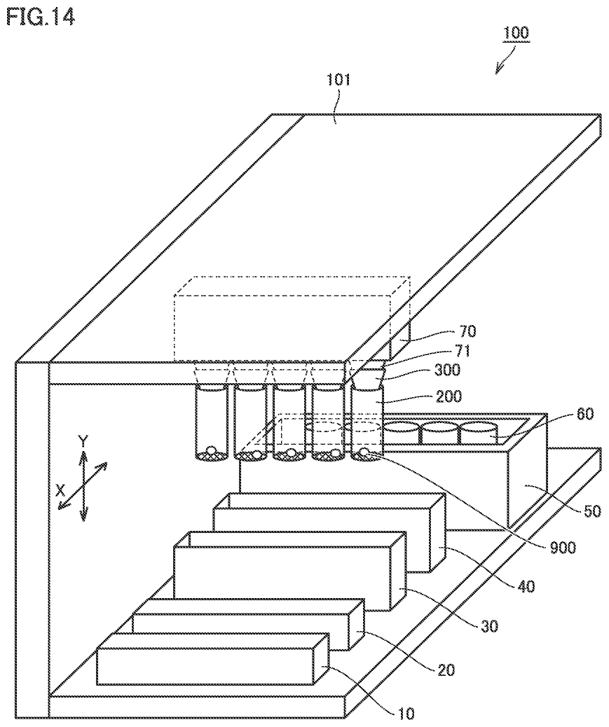

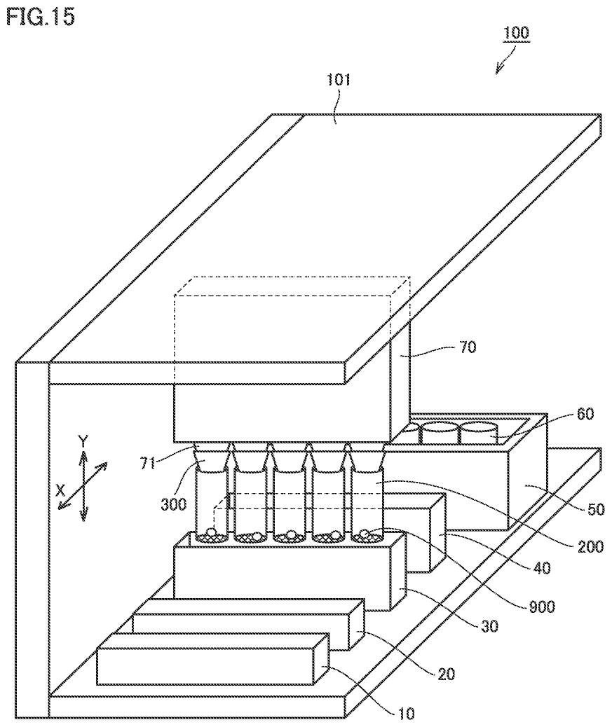

Freezing apparatus 100 then moves nozzle 71 upward (FIG. 13) and moves electric pipetter 70 to above ES reservoir 30 (FIG. 14). Freezing apparatus 100 then moves nozzle 71 downward to a position at which bottom 202 of tube 200 faces the ES in ES reservoir 30 (FIG. 15).

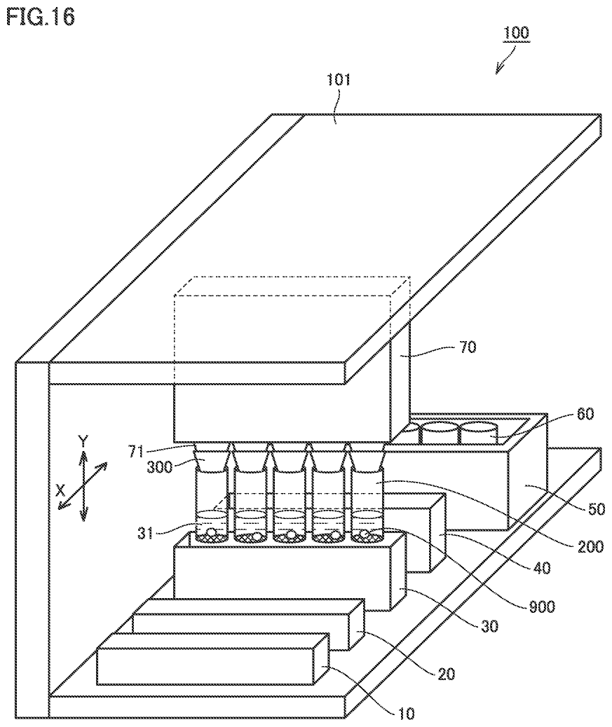

Returning to FIG. 6, in step SA220, freezing apparatus 100 injects the ES into tube 200. The injection of the ES into tube 200 will be described with reference to FIGS. 15 and 16.

Freezing apparatus 100 causes nozzle 71 to suck air when bottom 202 of tube 200 is positioned to face the ES as shown in FIG. 15. Thus, ES 31 is injected into tube 200 through the opening of bottom 202 as shown in FIG. 16. ES 31 injected into tube 200 remains in tube 200 by surface tension.

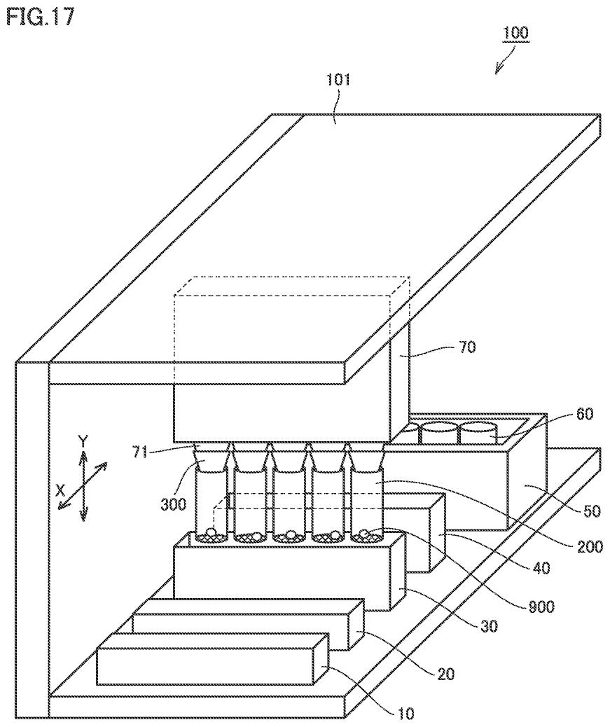

Returning to FIG. 6, in step SA230, freezing apparatus 100 discharges the ES from tube 200. Freezing apparatus 100 then returns control to FIG. 5. The discharge of the ES will be described with reference to FIGS. 16 and 17.

Freezing apparatus 100 discharges air into tube 200 through nozzle 71 with ES 31 injected into tube 200 as shown in FIG. 16. Thus, the ES is discharged through the gap between the meshes of bottom 202 of tube 200, as shown in FIG. 17. In this sense, bottom 202 is an example of the placement portion that allows the liquid to pass therethrough and the freezing target to be placed therein. Freezing apparatus 100 may further include a vessel for storing the ES discharged from tube 200.

Returning to FIG. 5, in step SA30, freezing apparatus 100 performs vitrification of freezing target 900. FIG. 7 shows a subroutine of step SA30.

Referring to FIG. 7, in step SA310, freezing apparatus 100 moves tube 200 to VS reservoir 40. An example of the movement of tube 200 to VS reservoir 40 will be described with reference to FIGS. 17 to 20.

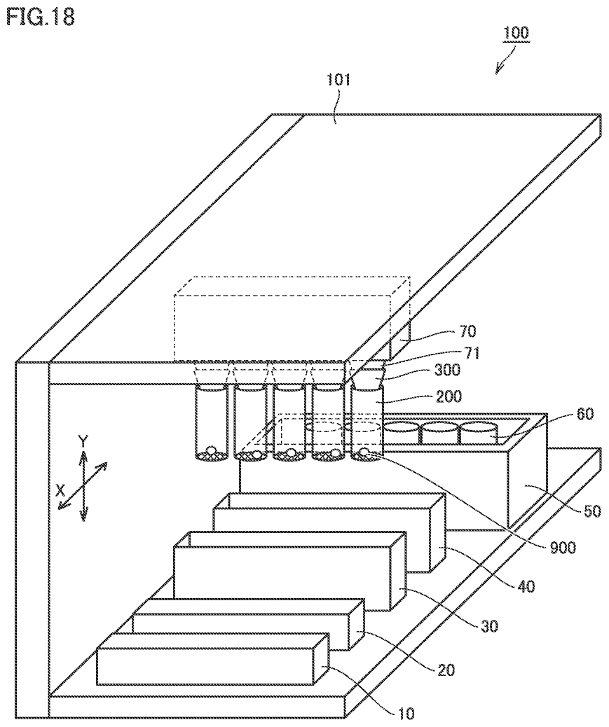

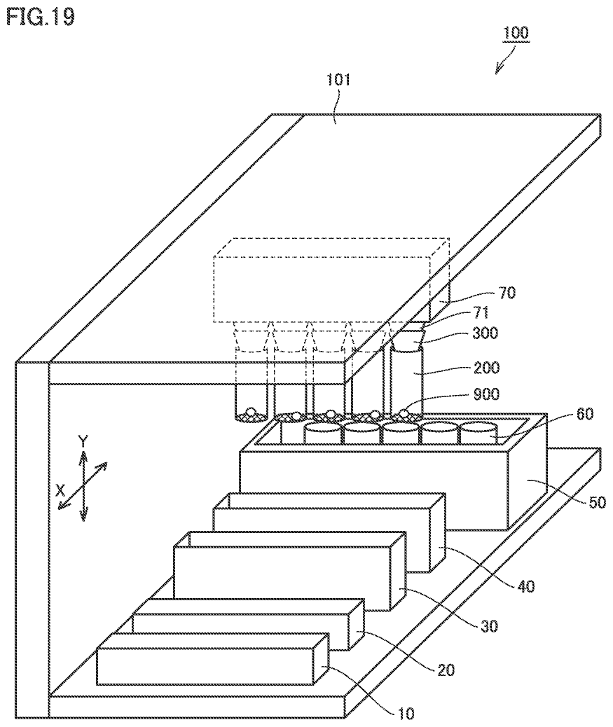

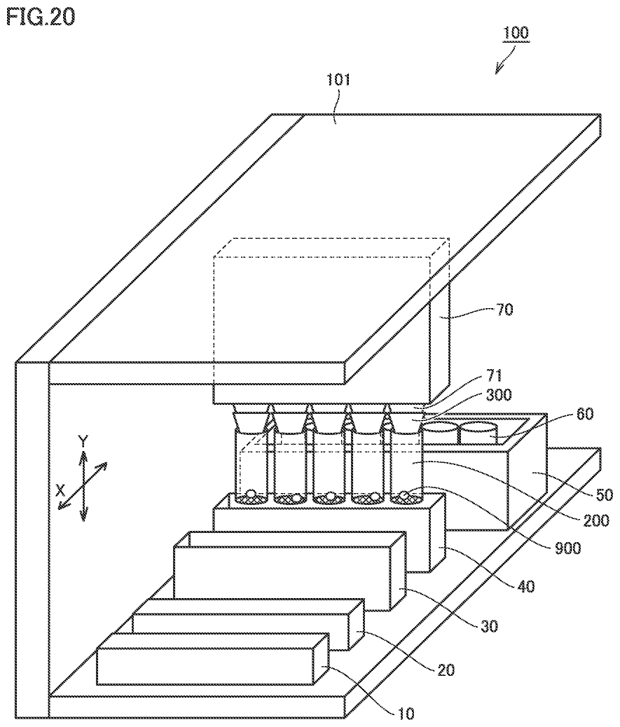

Freezing apparatus 100 discharges the ES from tube 200 (FIG. 17), moves electric pipetter 70 upward (FIG. 18), and then, moves electric pipetter 70 to above VS reservoir 40 (FIG. 19). Freezing apparatus 100 then moves nozzle 71 downward to a position at which bottom 202 of tube 200 faces the VS in VS reservoir 40 (FIG. 20).

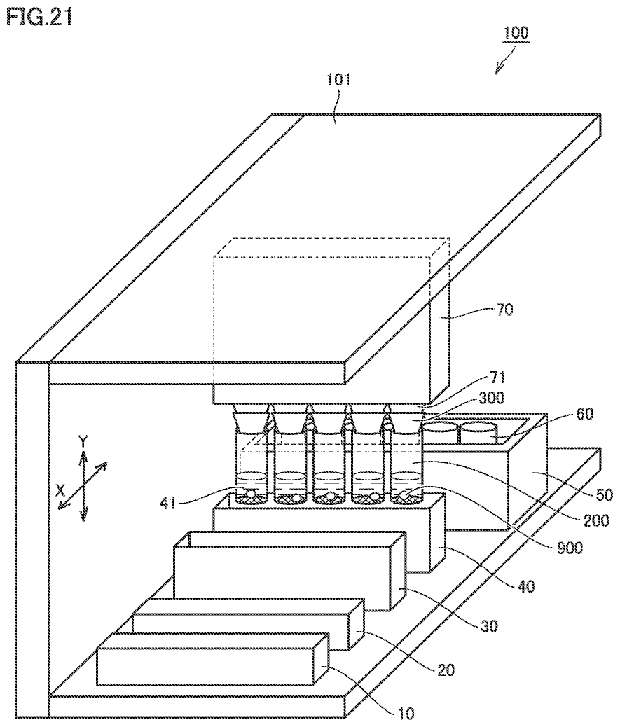

Returning to FIG. 7, in step SA320, freezing apparatus 100 injects the VS into tube 200. The injection of the VS into tube 200 will be described with reference to FIGS. 20 and 21.

When bottom 202 of tube 200 is positioned to face the VS as shown in FIG. 20, freezing apparatus 100 causes nozzle 71 to suck air. Thus, VS 41 is injected into tube 200 through the opening of bottom 202, as shown in FIG. 21. VS 41 injected into tube 200 remains in tube 200 by surface tension.

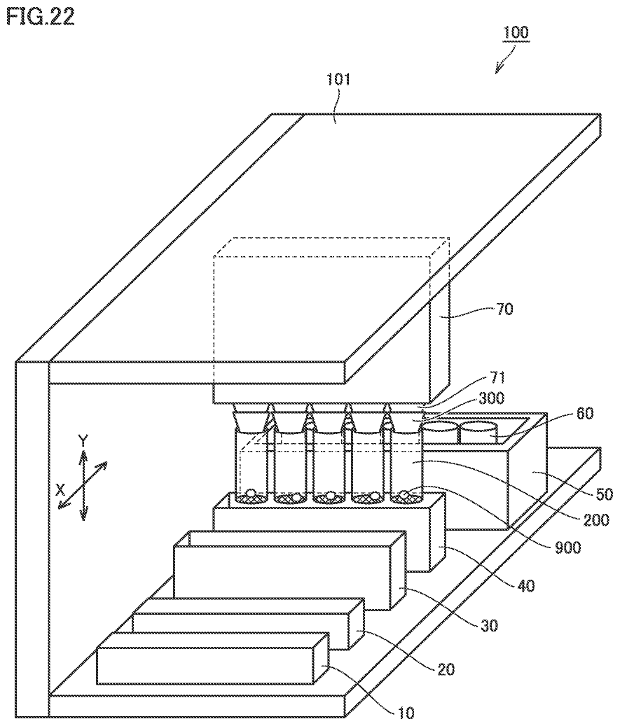

Returning to FIG. 7, in step SA330, freezing apparatus 100 discharges the VS from tube 200. Freezing apparatus 100 then returns control to FIG. 5. The discharge of the VS will be described with reference to FIGS. 21 and 22.

Freezing apparatus 100 discharges air into tube 200 from nozzle 71 with VS 41 injected into tube 200 as shown in FIG. 21. Thus, the VS is discharged from tube 200 as shown in FIG. 22. Freezing apparatus 100 may further include a vessel for storing the VS discharged.

Returning to FIG. 5, in step SA40, freezing apparatus 100 freezes freezing target 900 in tube 200. Freezing apparatus 100 then ends the process of FIG. 5.

Freezing of freezing target 900 in step SA40 will be descried with reference to FIGS. 22 to 28.

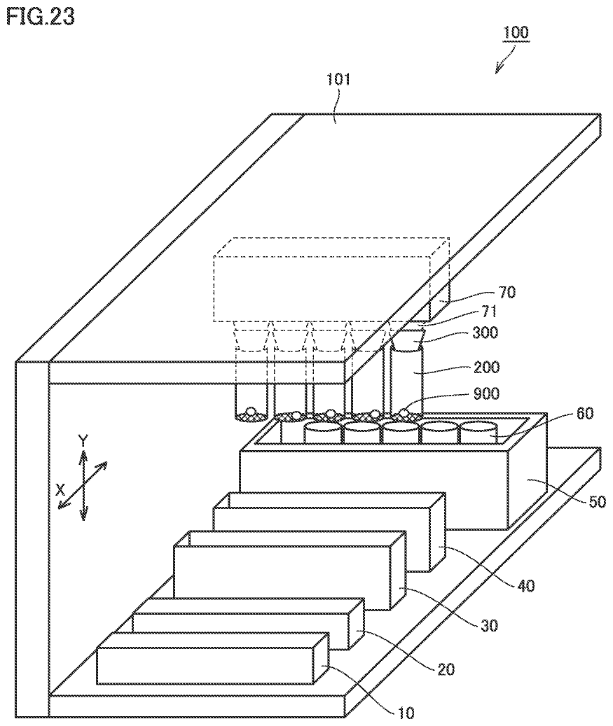

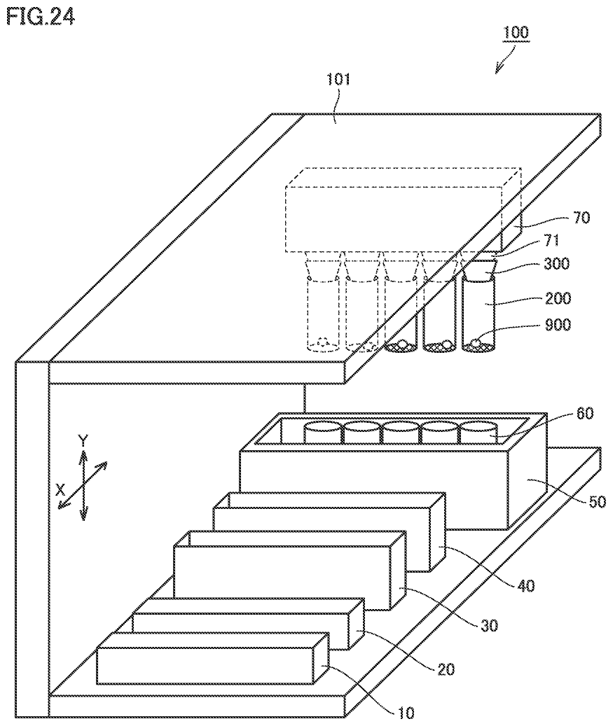

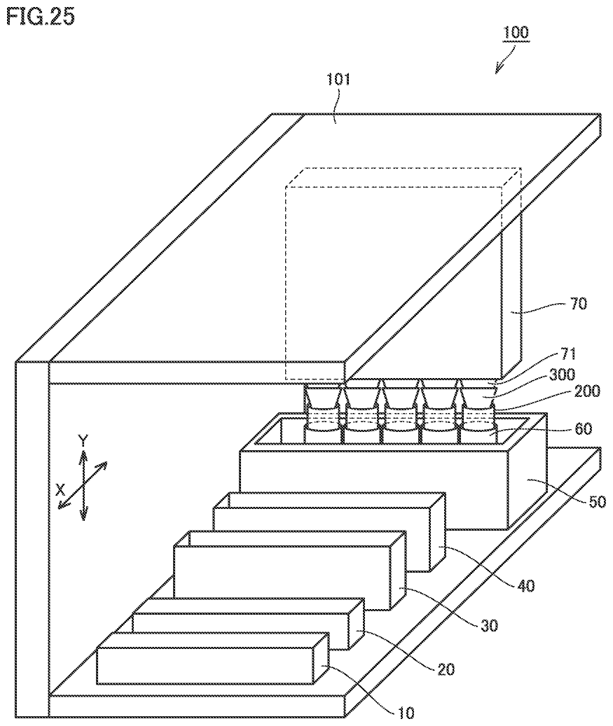

After the discharge of the VS from tube 200 (FIG. 22), freezing apparatus 100 raises nozzle 71 with tube 200 and cap 300 attached thereto upward (FIG. 23), and moves electric pipetter 70 such that tube 200 is located above freezing cane 60 in liquid nitrogen tank 50 (FIG. 24). Freezing apparatus 100 then lowers nozzle 71 (FIG. 25). Thus, tube 200 is housed in freezing cane 60.

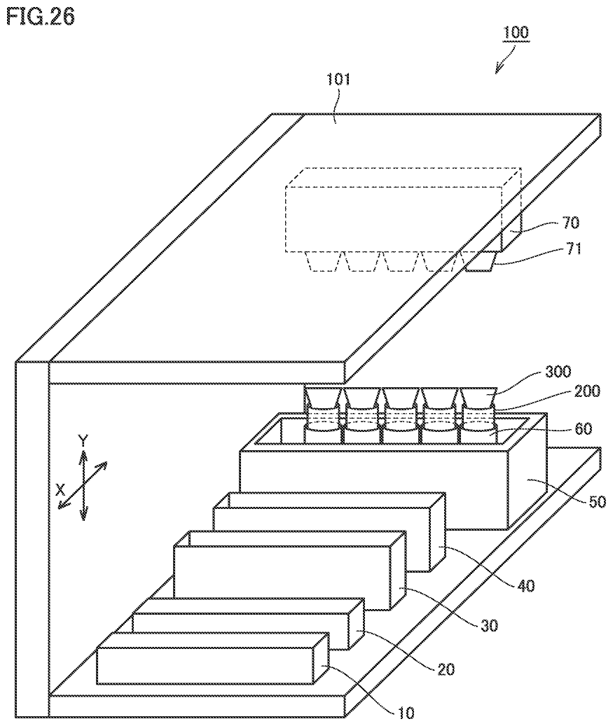

Freezing apparatus 100 then drives eject motor 171 while raising nozzle 71 upward, thereby detaching cap 300 from nozzle 71 (FIG. 26).

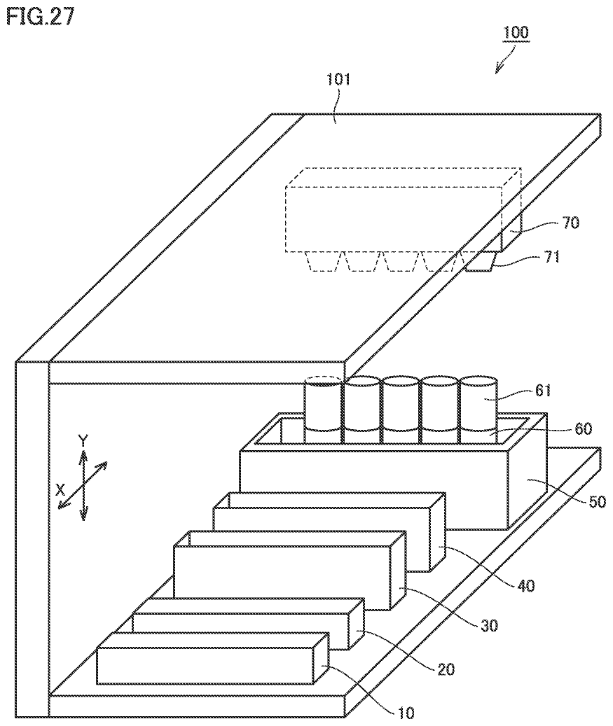

Then, a lid 61 is attached to freezing cane 60 (FIG. 27). Lid 61 may be attached manually or by freezing apparatus 100.

As described above, freezing apparatus 100 freezes a freezing target.

In the process described with reference to FIGS. 6 to 27, the injection of the liquid (ES or VS) into tube 200 is performed by sucking with nozzle 71. However, the liquid injection method is not limited thereto. For example, the liquid may be injected into tube 200 as tube 200 is immersed in a tank that stores the liquid. In this case, the size of the opening (gap between meshes) of bottom 202 may be larger than the size that allows the liquid to remain in tube 200 by surface tension. Also in the process described with reference to FIGS. 6 to 27, the size of the opening may be larger than the size that allows the liquid to remain in tube 200 by surface tension.

In the process described with reference to FIGS. 6 to 27, the discharge of the liquid (ES or VS) from tube 200 is performed by the discharge of air with nozzle 71. However, the discharge method is not limited thereto. For example, the opening of bottom 202 may be adjusted such that the liquid is discharged from tube 200 as tube 200 immersed in the tank is raised from the tank. The liquid may be discharged from tube 200 after a given period of time has elapsed since the injection of the liquid into tube 200.

### Embodiment 2

<Automatic Freezing Treatment Apparatus>

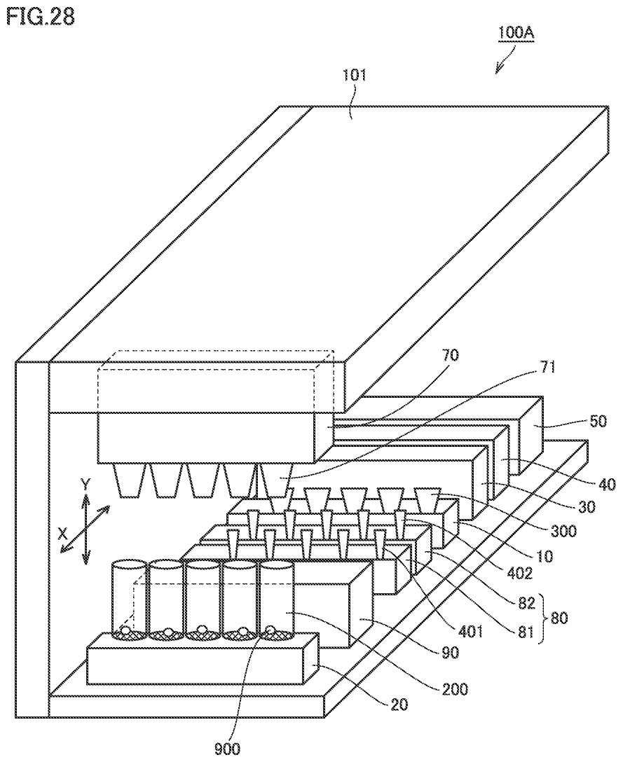

FIG. 28 schematically shows an overall configuration of a freezing apparatus 100A. Freezing apparatus 100A is an example of the automatic freezing processing apparatus. Regarding freezing apparatus 100A, a change to freezing apparatus 100 will be mainly described below.

Compared with freezing apparatus 100 shown in FIG. 1, freezing apparatus 100A further includes a chip holder 80 and a vessel 90. Chip holder 80 includes a chip holder for ES 81 and a chip holder for VS 82. Chip holder for ES 81 is equipped with a chip for ES 401. Chip holder for VS 82 is equipped with a chip for VS 402.

<Flow of Treatment>

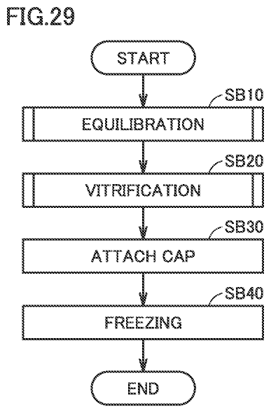

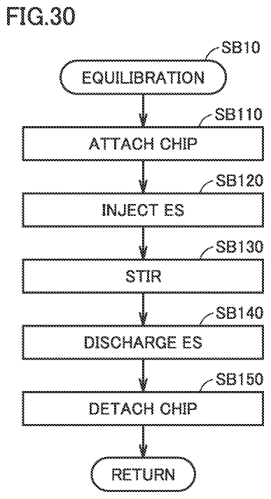

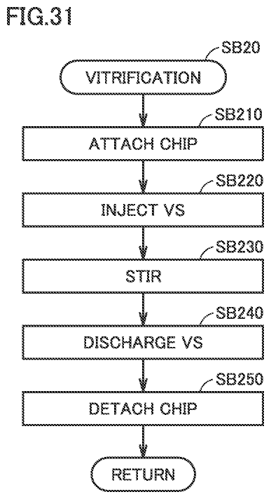

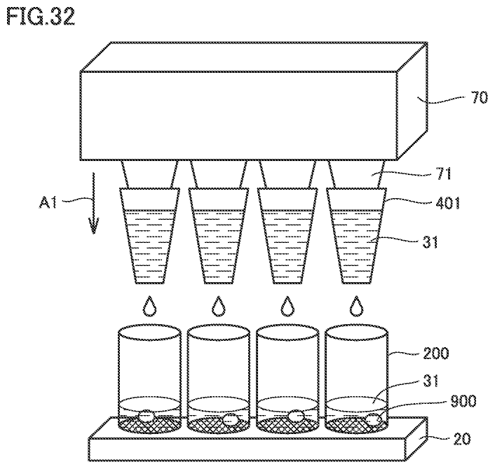

FIG. 29 is a flowchart of a process performed in freezing apparatus 100A. FIGS. 30 and 31 are each flowcharts of subroutines of the process of FIG. 29. FIGS. 32 to 34 are each diagrams for illustrating states of freezing apparatus 100A. In one implementation, freezing apparatus 100A performs the process of FIG. 29 as CPU 121 executes a given program. The process of FIG. 29 starts with freezing target 900 stored in tube 200 as shown in FIG. 28.

Referring to FIG. 29, in step SB10, freezing apparatus 100A performs equilibration of freezing target 900. FIG. 30 shows a subroutine of step SB10.

Referring to FIG. 30, in step SB110, freezing apparatus 100A attaches chip 401 to nozzle 71. More specifically, freezing apparatus 100A moves electric pipetter 70 to above chip holder for ES 81, and then, lowers nozzle 71 to a position at which nozzle 71 is fitted into chip 401. Thus, chip 401 is attached to nozzle 71.

In step SB120, freezing apparatus 100A injects the ES into tube 200. More specifically, freezing apparatus 100A moves nozzle 71 with chip 401 attached thereto upward, moves electric pipetter 70 to ES reservoir 30, lowers nozzle 71, and drives pump 151. Thus, chip 401 sucks the ES. Freezing apparatus 100A then moves nozzle 71 upward, moves electric pipetter 70 to tube holder 20, and lowers nozzle 71.

Freezing apparatus 100 then drives pump 151. Thus, chip 401 discharges the ES into tube 200, and the ES is injected into tube 200. FIG. 32 shows the ES injected into tube 200 as “ES 31”. In FIG. 32, an arrow A1 indicates a direction in which the ES is discharged.

Returning to FIG. 30, in step SB130, freezing apparatus 100A stirs the liquid inside tube 200. In one implementation, freezing apparatus 100A drives pump 151, thereby causing chip 401 to discharge air into tube 200. The liquid in tube 200 is stirred by the discharged air. Freezing apparatus 100A may stir the liquid in tube 200 by causing chip 401 to repeatedly discharge and suck air. Freezing apparatus 100A may stir the liquid in tube 200 by rocking tube holder 20.

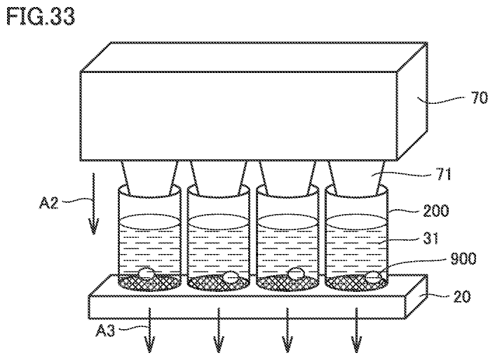

In step SB140, freezing apparatus 100A discharges the ES from tube 200. In one implementation, freezing apparatus 100 inserts chip 401 into the upper portion of tube 200, as shown in FIG. 33, by lowering nozzle 71. Thus, tube 200 is sealed by chip 401 and electric pipetter 70. In this state, freezing apparatus 100 sends air into tube 200 through chip 401. This causes the ES in tube 200 to be discharged through the opening of bottom 202. In FIG. 33, an arrow A2 indicates a direction in which air is sent. An arrow A3 indicates a direction in which the ES is discharged.

Returning to FIG. 30, in step SB150, freezing apparatus 100A detaches chip 401 from nozzle 71. More specifically, freezing apparatus 100A moves nozzle 71 upward, moves electric pipetter 70 to above vessel 90, and drives eject motor 171, thereby detaching chip 401 from nozzle 71. The detached chip 401 is housed in vessel 90. Freezing apparatus 100A returns control to FIG. 29 after step SB150.

Returning to FIG. 29, in step SB20, freezing apparatus 100 performs vitrification of freezing target 900. FIG. 31 shows a subroutine of step SB20.

Referring to FIG. 31, in step SB210, freezing apparatus 100A attaches chip 402 to nozzle 71. More specifically, freezing apparatus 100A moves electric pipetter 70 to above chip holder for VS 82, and then, moves nozzle 71 to a position at which nozzle 71 is fitted into chip 402. Thus, chip 402 is attached to nozzle 71.

In step SB220, freezing apparatus 100A injects the VS into tube 200. More specifically, freezing apparatus 100A moves nozzle 71 with chip 402 attached thereto upward, moves electric pipetter 70 to VS reservoir 40, lowers nozzle 71, and drives pump 151. Thus, chip 402 sucks the VS. Freezing apparatus 100A then moves nozzle 71 upward, moves electric pipetter 70 to tube holder 20, and lowers nozzle 71. Freezing apparatus 100 then drives pump 151. Thus, chip 402 discharges the VS into tube 200.

In step SB230, freezing apparatus 100A stirs the liquid inside tube 200 as in step SB130.

In step SB240, freezing apparatus 100A discharges the VS from tube 200 as in step SB140.

In step SB250, freezing apparatus 100A detaches chip 402 from nozzle 71 as in step SB150. Freezing apparatus 100A then returns control to FIG. 29.

Returning to FIG. 29, in step SB30, freezing apparatus 100A attaches cap 300 to tube 200. In one implementation, freezing apparatus 100A attaches, to tube 200, cap 300 attached to nozzle 71, as described with reference to FIGS. 8 to 12.

In step SB40, freezing apparatus 100A freezes freezing target 900 in tube 200. Freezing apparatus 100A then ends the process of FIG. 29.

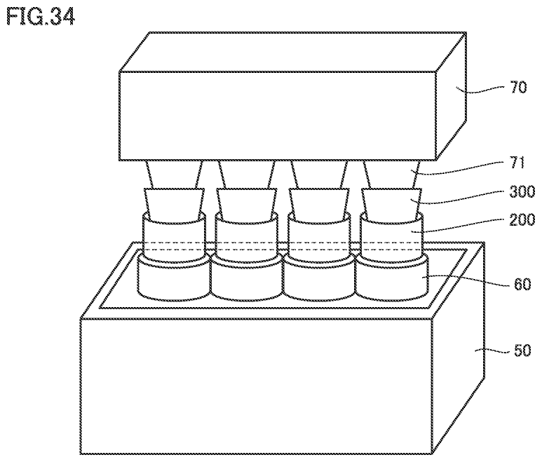

In one implementation, in step SB40, freezing apparatus 100A houses tube 200 and cap 300 attached to nozzle 71 in freezing cane 60, as described with reference to FIGS. 22 to 25. The state at this time is also shown in FIG. 34. Freezing apparatus 100A then drives eject motor 171, thereby detaching cap 300 from nozzle 71. Freezing apparatus 100A then returns nozzle 71 to the position shown in FIG. 28. A lid 61 is attached to freezing cane 60.

In the process described with reference to FIGS. 28 to 34, the liquid (ES or VS) is injected into tube 200. The injected liquid does not leak through the opening of bottom 202 of tube 200 by surface tension. Subsequently, air is discharged into tube 200, so that the liquid is discharged from tube 200 through the opening of bottom 202. The discharge of the liquid from tube 200 may be performed after a given period of time has elapsed since the injection of the liquid into tube 200.

[Variation]

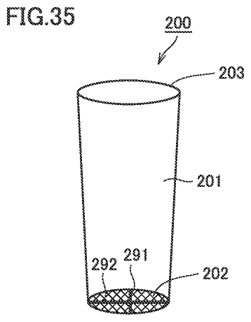

FIG. 35 shows a variation of tube 200. As shown in FIG. 35, bottom 202 of tube 200 may be provided with supports 291, 292. Supports 291, 292 are made of, for example, a material similar to that of base 201 of tube 200. This reliably avoids damage to the net structure (or porous structure) of bottom 202 due to a volume change resulting from a temperature change caused by freezing or the like. Bottom 302 of cap 300 may also be provided with supports similar to supports 291, 292.

[Aspects]

It will be appreciated by a person skilled in the art that the exemplary embodiments described above provide specific examples of the following aspects.

(Clause 1) An automatic freezing processing apparatus according to an aspect may include a vessel that stores a freezing target, a working unit configured for injection and discharge of a liquid into and from the vessel and for movement of the vessel, and a refrigerant container that stores refrigerant for freezing the freezing target. The vessel may have, at a bottom thereof, an opening smaller in size than the freezing target. The working unit may discharge the liquid from the vessel through the opening after the injection of the liquid into the vessel, and move the vessel to the refrigerant container.

With the automatic freezing processing apparatus according to clause 1, in freeze-preservation, a burden on the operator in the pretreatment of the freezing target is reduced while avoiding a situation where the freezing target is accidentally collected and a situation where a liquid to be collected remains in the freezing target.

(Clause 2) In the automatic freezing processing apparatus according to clause 1, the injection of the liquid into the vessel may include injection of the liquid into the vessel from above the vessel, and the discharge of the liquid from the vessel may include sending air to the vessel from above.

With the automatic freezing processing apparatus according to clause 2, the liquid moves to the vessel under its own weight, thus allowing for more reliable injection of the liquid into the vessel.

(Clause 3) In the automatic freezing processing apparatus according to clause 2, the injection of the liquid into the vessel from above the vessel may include injection of the liquid using a chip.

With the automatic freezing processing apparatus according to clause 3, the liquid is injected into the vessel more reliably.

(Clause 4) In the automatic freezing processing apparatus according to clause 1, the injection of the liquid into the vessel may include sucking the liquid into the vessel from a tank that stores the liquid.

With the automatic freezing processing apparatus according to clause 4, the liquid is injected into the vessel reliably by a suction strength.

(Clause 5) In the automatic freezing processing apparatus according to any one of clauses 1 to 4, the working unit may perform an operation for stirring the liquid in the vessel between the injection of the liquid into the vessel and the discharge of the liquid from the vessel.

With the automatic freezing processing apparatus according to clause 5, the liquid acts on the freezing target in the vessel more reliably.

(Clause 6) The automatic freezing processing apparatus according to clause 5 may further include a pump that discharges air to the vessel for the operation.

With the automatic freezing processing apparatus according to clause 6, the liquid is stirred readily.

(Clause 7) In the automatic freezing processing apparatus according to any one of clauses 1 to 6, the working unit may attach a cap to the vessel.

With the automatic freezing processing apparatus according to clause 7, leakage of the freezing target in the vessel from the vessel is avoided more reliably.

(Clause 8) In the automatic freezing processing apparatus according to clause 7, the cap may have an opening smaller in size than the freezing target.

With the automatic freezing processing apparatus according to clause 8, the liquid can be injected into the vessel with the cap attached thereto while avoiding a situation where the freezing target in the vessel leaks from the vessel.

(Clause 9) In the automatic freezing processing apparatus according to any one of clauses 1 to 8, the injection of the liquid into the vessel may include injection of an equilibration solution into the vessel, and injection of a vitrification solution into the vessel after discharge of the equilibration solution from the vessel.

With the automatic freezing processing apparatus according to clause 9, a burden on the operator is reduced in both equilibration and vitrification of the freezing target.

(Clause 10) An automatic freezing processing method according to an aspect may include: injecting a liquid into a vessel having, at a bottom thereof, an opening smaller in size than a freezing target; discharging the liquid from the vessel through the opening after injecting the liquid; and moving the vessel to a refrigerant container after discharging the liquid.

With the automatic freezing processing method according to clause 10, in freeze-preservation, a burden on the operator in the pretreatment of the freezing target is reduced while avoiding a situation where the freezing target is accidentally collected and a situation where a liquid to be collected remains in the freezing target.

(Clause 11) A freezing vessel according to an aspect is a freezing vessel for immersing a freezing target into a liquid for a freezing pretreatment. The freezing vessel may include a placement portion that allows the liquid to pass therethrough and the freezing target to be placed therein.

With the freezing vessel according to clause 11, in freeze-preservation, a burden on the operator in the pretreatment of the freezing target is reduced while avoiding a situation where the freezing target is accidentally collected and a situation where a liquid to be collected remains in the freezing target.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An automatic freezing processing apparatus comprising:
a vessel that stores a freezing target;
a working unit configured for injection and discharge of a liquid into and from the vessel and for movement of the vessel; and
a refrigerant container that stores refrigerant for freezing the freezing target, wherein
the vessel has, at a bottom thereof, an opening smaller in size than the freezing target, and
the working unit discharges the liquid from the vessel through the opening after the injection of the liquid into the vessel, and moves the vessel to the refrigerant container.

2. The automatic freezing processing apparatus according to claim 1, wherein
the injection of the liquid into the vessel includes injection of the liquid into the vessel from above the vessel, and
the discharge of the liquid from the vessel includes sending air to the vessel from above.

3. The automatic freezing processing apparatus according to claim 2, wherein the injection of the liquid into the vessel from above the vessel includes injection of the liquid using a chip.

4. The automatic freezing processing apparatus according to claim 1, wherein the injection of the liquid into the vessel includes sucking the liquid into the vessel from a tank that stores the liquid.

5. The automatic freezing processing apparatus according to claim 1, wherein the working unit performs an operation for stirring the liquid in the vessel between the injection of the liquid into the vessel and the discharge of the liquid from the vessel.

6. The automatic freezing processing apparatus according to claim 5, further comprising a pump that discharges air to the vessel for the operation.

7. The automatic freezing processing apparatus according to claim 1, wherein the working unit attaches a cap to the vessel.

8. The automatic freezing processing apparatus according to claim 7, wherein the cap has an opening smaller in size than the freezing target.

9. The automatic freezing processing apparatus according to claim 1, wherein the injection of the liquid into the vessel includes
injection of an equilibration solution into the vessel, and
injection of a vitrification solution into the vessel after discharge of the equilibration solution from the vessel.

10. An automatic freezing processing method comprising:
injecting a liquid into a vessel having, at a bottom thereof, an opening smaller in size than a freezing target;
discharging the liquid from the vessel through the opening after injecting the liquid; and
moving the vessel to a refrigerant container after discharging the liquid.

11. A freezing vessel for immersing a freezing target into a liquid for a freezing pretreatment, the freezing vessel comprising
a placement portion that allows the liquid to pass therethrough and the freezing target to be placed therein.
